(19) United States
(12) Patent Application Publication
(10) Pub. No.: US 2012/0306617 A1
(43) Pub. Date: Dec. 6, 2012

(54) COMPOSITE LOCK

(75) Inventor: Chia-Chun Tung, Taipei (TW)

(73) Assignee: DEUTRON ELECTRONICS CORP., Taipei (TW)

(21) Appl. No.: 13/196,621

(22) Filed: Aug. 2, 2011

(30) Foreign Application Priority Data
Jun. 1, 2011 (TW) 100209968

(51) Int. Cl. G06F 7/04; G06F 7/00

(52) U.S. Cl. 340/5.54; 340/5.2

(57) ABSTRACT

A composite lock includes a lock control unit and a Bluetooth unit. The Bluetooth unit is connected to the lock control unit, and the Bluetooth unit controls the lock control unit according to a result of pairing and authentication with a handheld unit, so as to enable the composite lock to be in a locking state or an unlocking state.

### CROSS-REFERENCE TO RELATED APPLICATIONS

This non-provisional application claims priority under 35 U.S.C. §119(a) on Patent Application No(s). 100209968 filed in Taiwan, R.O.C. on Jun. 1, 2011, the entire contents of which are hereby incorporated by reference.

### BACKGROUND

1. Technical Field

The disclosure relates to a lock, and more particularly to a lock capable of being controlled wirelessly.

2. Related Art

Locks develop with each passing day, and are diversified. In general, locks may be sorted in mechanical locks and combination locks. Operation of a common mechanical lock is: when a key is inserted into the lock, concave points or convex points on the key correspond to pins in the lock, and only when the pins each are moved to predetermined positions can a cam of the lock be rotated or moved axially for locking and unlocking. A combination lock has multiple dial rings. The inner surface of each dial ring has a notch. A cam has several teeth on it which hook into the dial rings. When the dial rings rotate to the correct positions corresponding to the passwords, the combination lock is unlocked.

However, there are obvious defects in the applications of both the mechanical lock and the combination lock. With respect to the mechanical lock, a burglar can destroy the mechanical lock easily with hand tools. In addition, the mechanical lock does not have the functions of warning and deterring while being broken. Accordingly, burglary is easy. On the other hand, the combination lock is expensive. Besides, a user has to bear a password in mind, which brings inconvenience to the user.

### SUMMARY

Accordingly, the present disclosure relates to a composite lock comprising a lock control unit and a Bluetooth unit.

The lock control unit is used to control the composite lock for switching the composite lock between a locking state and an unlocking state.

The Bluetooth unit which is connected to the lock control unit is used to connect with a handheld unit and receive a returned signal from the handheld unit if the connection is valid. The received return signal is transmitted to the lock control unit by the Bluetooth unit to control the composite lock.

Only when the handheld unit is paired with the Bluetooth unit, i.e. the Bluetooth unit connected to the handheld unit and is identified, the composite lock of the present disclosure is unlocked. Therefore, security of the composite lock is improved.

### BRIEF DESCRIPTION OF THE DRAWINGS

The present disclosure will become more fully understood from the detailed description given herein below for illustration only, and thus are not limitative of the present disclosure, and wherein:

FIG. 1A, FIG. 1B, FIG. 1C, and FIG. 1D are schematic block diagrams of a first embodiment, a second embodiment, a third embodiment, and a fourth embodiment of a composite lock;

FIG. 2A and FIG. 2B are three dimensional views of a lock control unit at two different viewing angle, respectively;

FIG. 3A, FIG. 3B, and FIG. 3C are schematic block diagrams of a fifth embodiment, a sixth embodiment, and a seventh embodiment of the composite lock; and

FIG. 4A and FIG. 4B are three dimensional views of the lock control unit at two different viewing angle, respectively.

### DETAILED DESCRIPTION

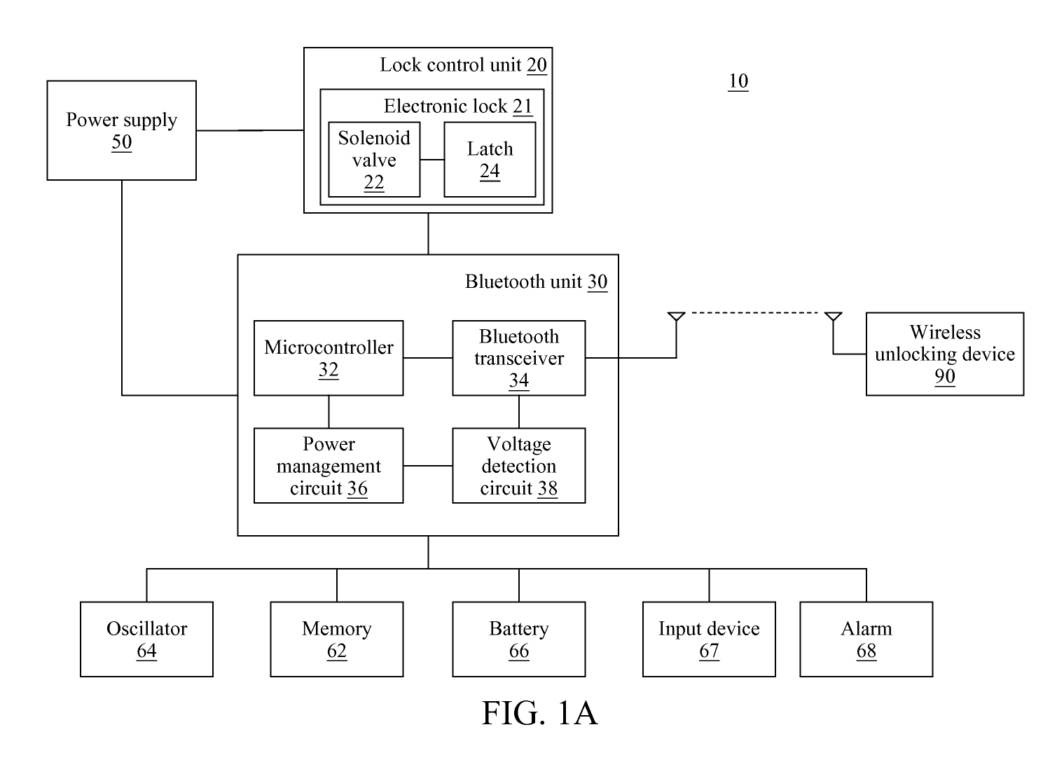

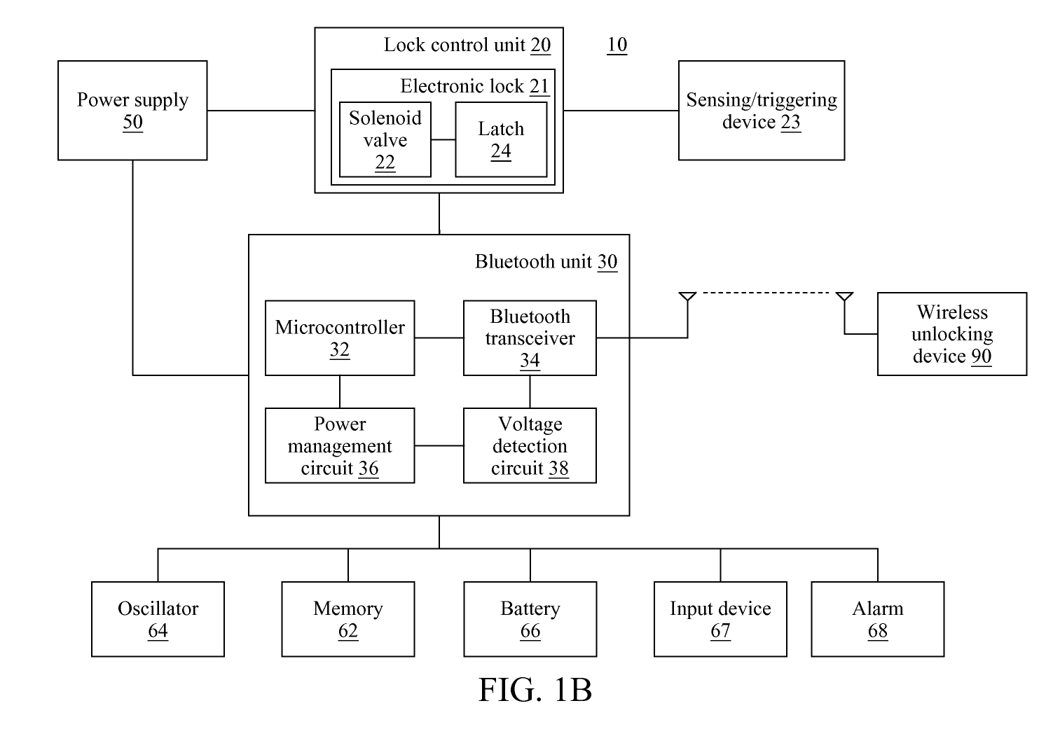

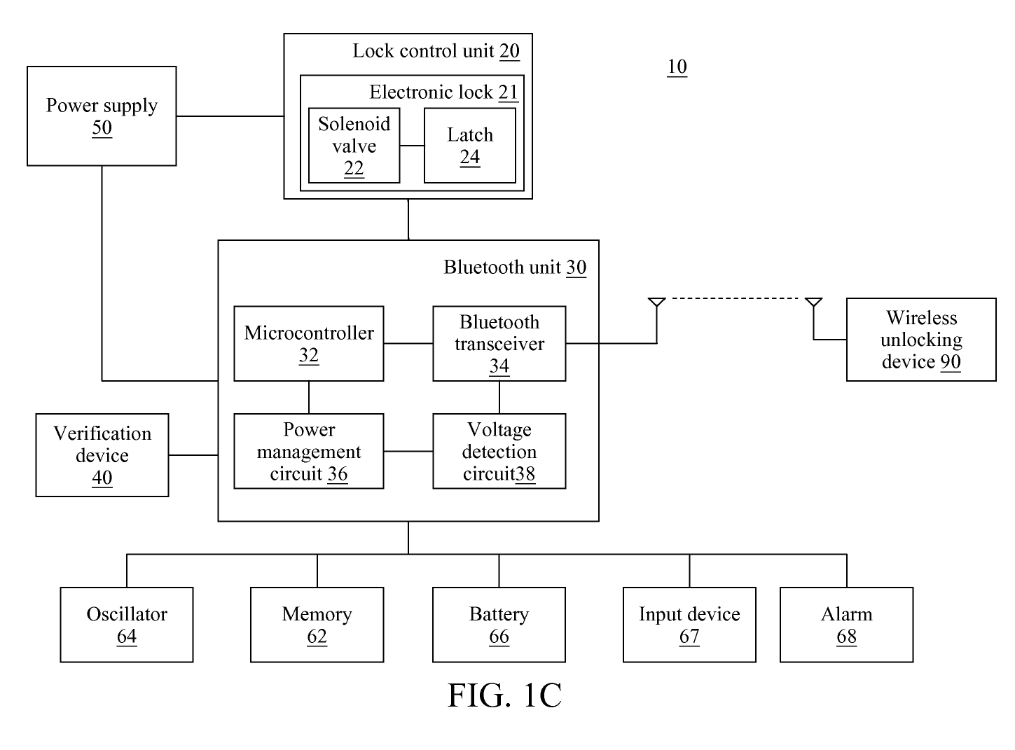

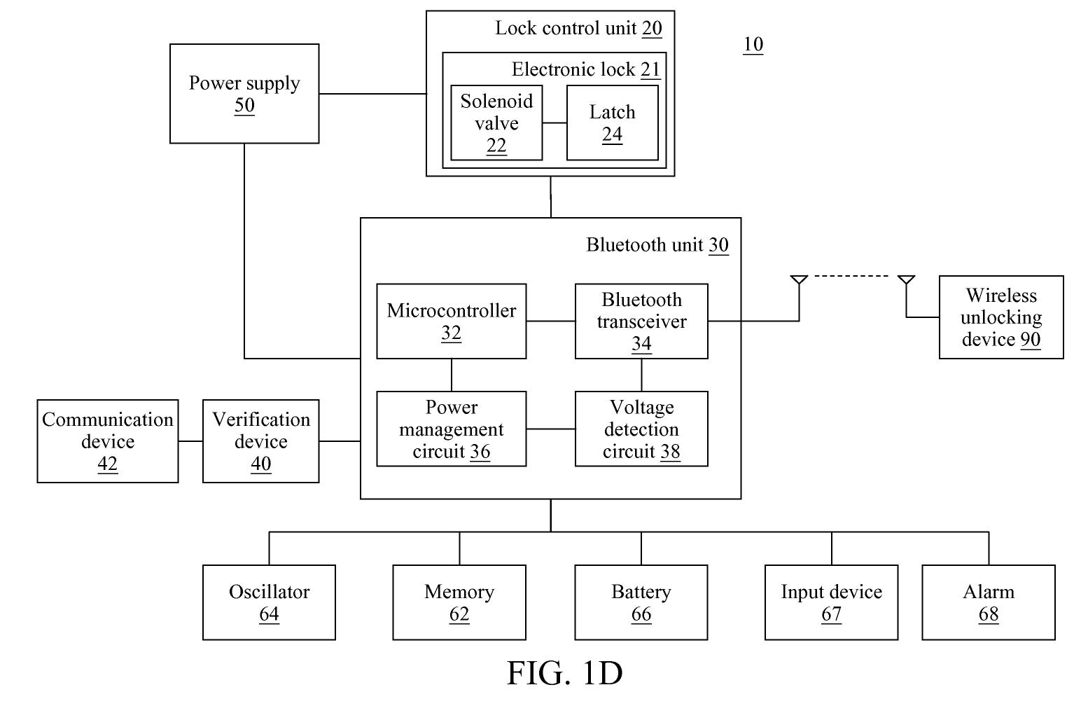

FIG. 1A is a schematic block diagram of a first embodiment of a composite lock. As shown in FIG. 1A, the composite lock of this embodiment may be used in a door, a safe box, a drawer, a mail box, a luggage, or a car.

A composite lock 10 is locked or unlocked with a handheld unit 90 which may be an electronic device with wireless-communication function, for example, a mobile phone, a smart phone, a notebook computer, or a tablet personal computer.

The composite lock 10 comprises a lock control unit 20 and a Bluetooth unit 30.

In this embodiment, the lock control unit 20 comprises an electronic lock 21 comprising a solenoid valve 22 and a latch 24.

The solenoid valve 22 may be an electrically controlled electromagnetic switch, for example, an electric dropbolt or an electric strike.

Controlled by the solenoid valve 22, the latch 24 may be moved between an extended position and a retracted position, so that the composite lock 10 is switched between a locked state and an unlocked state.

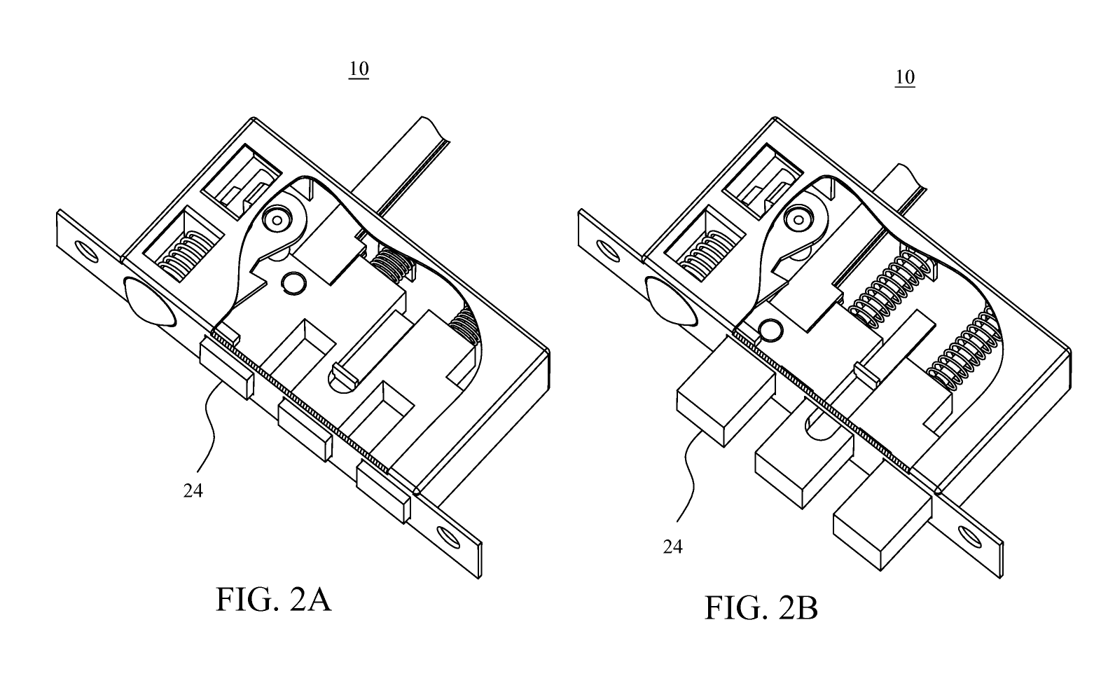

FIG. 2A illustrates that the latch 24 is in the retracted position (unlocking), and FIG. 2B illustrates that the latch 24 is in the extended position (locking).

The Bluetooth unit 30 comprises a microcontroller 32, a Bluetooth transceiver 34, a power management circuit 36, and a voltage detection circuit 38. The Bluetooth unit 30 is, for example, connected to a memory 62, an oscillator 64, a battery 66, an input device 67, and an alarm 68.

The microcontroller 32 may be a single-chip microprocessor. The microcontroller 32 runs a software program or a firmware program to control the Bluetooth transceiver 34 to perform Bluetooth protocol communication or judge a distance between an object and the Bluetooth transceiver 34. The microcontroller 32 may also control the lock control unit 20 to execute a locking action or an unlocking action. In addition, the microcontroller 32 may activate the alarm 68 for alarming.

The Bluetooth transceiver 34 is a wireless transmission element complying with Bluetooth communication specifications and operating on a frequency band of 2.4 Gigahertz (GHz). The Bluetooth transceiver 34 connects with, i.e. pairs with, with other Bluetooth devices with protocol connecting and identifying them. In addition, the Bluetooth transceiver 34 may provide the microcontroller 32 with detection data of the judged distances between each of the other Bluetooth devices and the Bluetooth transceiver 34.

The power management circuit 36 adjusts the voltage of a power supply 50 for supplying the converted voltage to each element for use. The power management circuit 36 may comprise multiple Direct Current (DC)/DC conversion circuits or Alternating Current (AC)/DC conversion circuits.

The voltage detection circuit 38 detects the power supply 50 and the battery 66. When the voltage is lower than a preset range, the voltage detection circuit 38 sends a message to the microcontroller 32 to generate an alarm for reminding a user to replace the battery, or disable the locking function, or enable auto-unlocking function, so as to avoid that the composite lock 10 cannot be unlocked since the battery 66 is dead.

The memory 62 is a non-volatile memory capable of repeated reading and writing of data. The memory 62 is used for storing preset data such as a working state of the microcontroller 32, pairing data, a detection distance, and a password.

The oscillator 64 provides a clock signal to the microcontroller 32 for work.

The battery 66 is a dry cell or a rechargeable battery.

The input device 67 may be a switch, a mechanical key button, or a touch screen for receiving the user's inputs of settings, for example, the detection distance or the password.

The alarm 68 comprises a buzzer and a Light Emitting Diode (LED) indicator for getting attention of the user by sound or light.

The composite lock may operate in one of the two following manners.

The first implementation manner refers to automatic locking and identification-based unlocking. The second implementation manner refers to identification-based locking and identification-based unlocking. The implementation manner may be chosen by the user, or set in a product before the shipment of the composite lock 10.

Before the user uses the composite lock 10 for the first time, the handheld unit 90 of the user may be paired with, i.e. connected with, the composite lock 10, and then the identification of the handheld unit 90 may be stored in the memory 62.

With respect to the automatic locking, the Bluetooth unit 30 is not involved in the locking process. However, in identification-based locking or identification-based unlocking, locking has to be performed through the Bluetooth unit 30. The manner of identification-based locking or identification-based unlocking is described below in detail.

The manner of identification-based unlocking or identification-based locking may be performed in either automatic activation mode (corresponding to FIG. 1A) or trigger-based activation mode (corresponding to FIG. 1B).

In the automatic activation mode, when the handheld unit 90 approaches the composite lock 10, the Bluetooth unit 30 may first receive a response signal from the handheld unit 90, and verify the handheld unit 90 with both the stored identification data and the response signal. When such verification is passed, the judged distance, estimated by the Bluetooth transceiver 34, from the handheld unit 90 to the composite lock 10 is compared with a threshold value which may be set by the user or pre-stored in the memory. If the judged distance is smaller than the threshold value, the Bluetooth unit 30 outputs an unlocking signal to the lock control unit 20, and then the solenoid valve 22 of the electronic lock 21 moves from the extended position to the retracted position. As a result, the composite lock 10 is in the unlocking state.

On the other hand, identification-based locking can also be performed in either an automatic activation mode or a trigger-based activation mode. The automatic activation mode and the trigger-based activation mode are both similar to the process of the identification-based unlocking. When the verification is passed, the Bluetooth unit 30 outputs a locking signal to the lock control unit 20, and then the solenoid valve 22 of the electronic lock 21 moves from the retracted position to the extended position. As a result, the composite lock 10 is in the locking state.

In the automatic activation mode, according to the changes in the distances estimated by the Bluetooth unit 30, the identification-based unlocking and the identification-based locking may be correctly performed by the composite lock 10. For example, decreasing of the distance judged by the Bluetooth unit 30 represents that the handheld unit 90 is approaching the composite lock 10, and the identification-based unlocking process is executed. On the contrary, increasing of the distance detected by the Bluetooth unit 30 represents that the handheld unit 90 is departing from the composite lock 10, and the identification-based locking process is executed.

The Bluetooth unit 30 also can perform the verification by requesting a password from the handheld unit 90 instead of the verification of the stored identification data. Only when the password input from the handheld unit 90 is correct and the distance judged is smaller than the threshold value, does the Bluetooth unit 30 transmit the unlocking signal to the lock control unit 20. Timing of inputting password and the times allowed for wrong password input may be set by initial setting.

In the trigger-based activation mode, the user triggers the composite lock 10 before opening a door. FIG. 1B is a schematic block diagram of a second embodiment of the composite lock. A sensing device 23 in the composite lock 10 can detect an action exerted by the user on the composite lock 10, such as pressing, rotating, moving, touching, and knocking. The sensing device 23 generates a triggering signal according to a detection result, and sends the triggering signal to the Bluetooth unit 30. After receiving the triggering signal, the Bluetooth unit 30 may connect to the handheld unit 90 and then performs verification according to stored identification data. When the verification is passed, the Bluetooth unit 30 transmits an unlocking signal to the lock control unit 20 for controlling the solenoid valve 22 of the electronic lock 21 to moves from the extended position to the refracted position.

In the trigger-based activation mode, when the sensing device 23 receives a sensing signal generated according to the action exerted by the user on the sensing device 23 and the handheld unit 90 is not yet detected by the Bluetooth unit 30, the alarm 68 warns the user by emitting sound or light. For example, when the sensing device 23 detects that the user goes out and closes the door, and the handheld unit 90 is not detected by the Bluetooth unit 30 within a communication distance, the microcontroller 32 of the composite lock 10 may control the alarm 68 to remind the user by sound or light that the handheld unit 90 is not carried with. Therefore, the problem of using conventional locks is prevented in which the user forgets to carry the key and is locked outside the door.

Besides verifying the stored identification data, the Bluetooth unit 30 can further request the password from the handheld unit 90. Only when both the password input by the handheld unit 90 is correct and the verification of the identification data is passed, does the Bluetooth unit 30 transmit an unlocking signal to the lock control unit 20. Timing of inputting password and the times allowed for wrong password input may be set by initial setting.

FIG. 1C is a schematic block diagram of a third embodiment of the composite lock.

The composite lock further comprises a verification device 40. In this embodiment, the verification device 40 may be a Dual Tone Multi Frequency (DTMF) decoder. The DTMF decoder can receive DTMF signals, and convert the DTMF signals into digital signals.

After the Bluetooth unit 30 performs the verification according to the stored identification data and the verification is passed, the Bluetooth unit 30 makes a call through the handheld unit 90. In this embodiment, the handheld unit 90 may have a mobile communication module employing a mobile communication standard, such as Global System for Mobile communications (GSM), third Generation (3G), or Long Term Evolution (LTE), and the mobile communication module can dial a remote control device. The telephone number of the remote control device may be stored in the memory 62. After receiving the call from the handheld unit 90, the remote control device which may be controlled by a monitor or a computer returns a verification signal to the handheld unit 90. The verification signal then returns from the handheld unit 90 to the Bluetooth unit 30 and then to the verification device 40. The verification device 40 generates a verification code according to the verification signal. The microcontroller 32 may compare the verification code with a preset password to check if the verification code is valid. If the verification code is valid, the Bluetooth unit 30 transmits an unlocking signal to the lock control unit 20 for controlling the solenoid valve 22 of the electronic lock 21 to move from the extended position to the retracted position.

Not only the handheld unit 90 but also the composite lock 10 can make a call. FIG. 1D is a schematic block diagram of a fourth embodiment of the composite lock.

The composite lock 10 further comprises a communication device 42 which may be a wired local telephone or a wireless mobile communication module. The composite lock 10 can make a call to a remote control device through the communication device 42. After the remote control device receives the call from the communication device 42, the remote control device which may be controlled by a monitor or a computer returns a verification signal to the communication device 42. The communication device 42 transmits the verification signal to the verification device 40, and the verification device 40 generates a verification code according to the verification signal. The microcontroller 32 may compare the verification code with a preset password to check whether the verification code is valid. If the verification code is valid, the Bluetooth unit 30 transmits an unlocking signal to the lock control unit 20 for controlling the solenoid valve 22 of the electronic lock 21 to moves from the extended position to the retracted position.

Making a call to the remote control device is like providing an additional verification mechanism to the composite lock 10, thereby improving security of the composite lock 10.

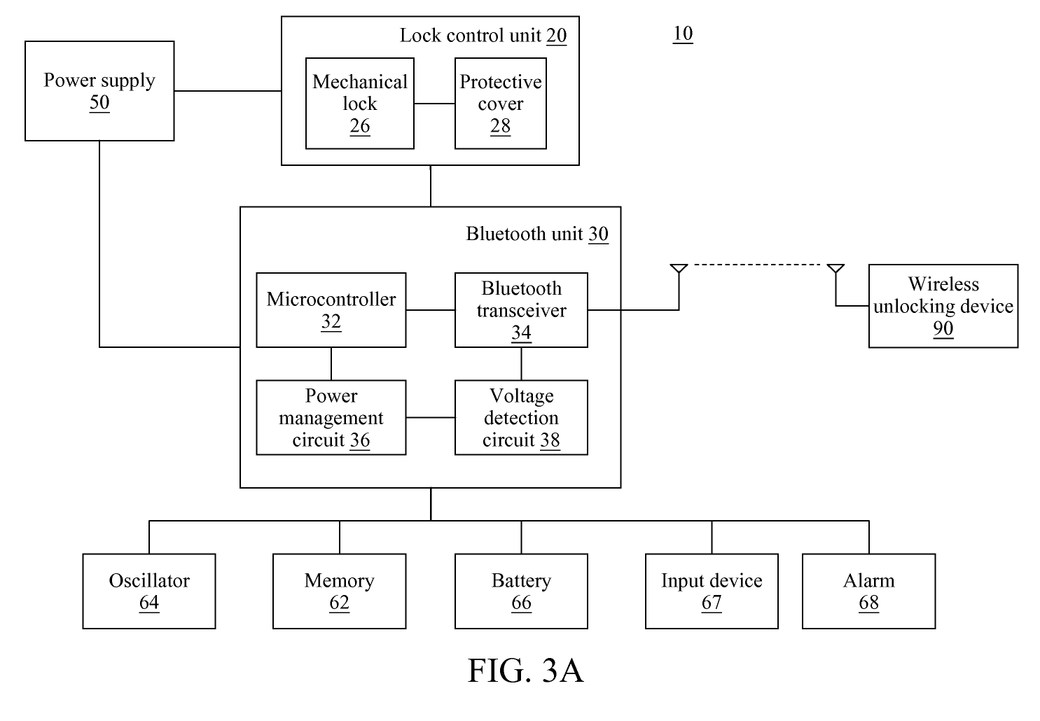

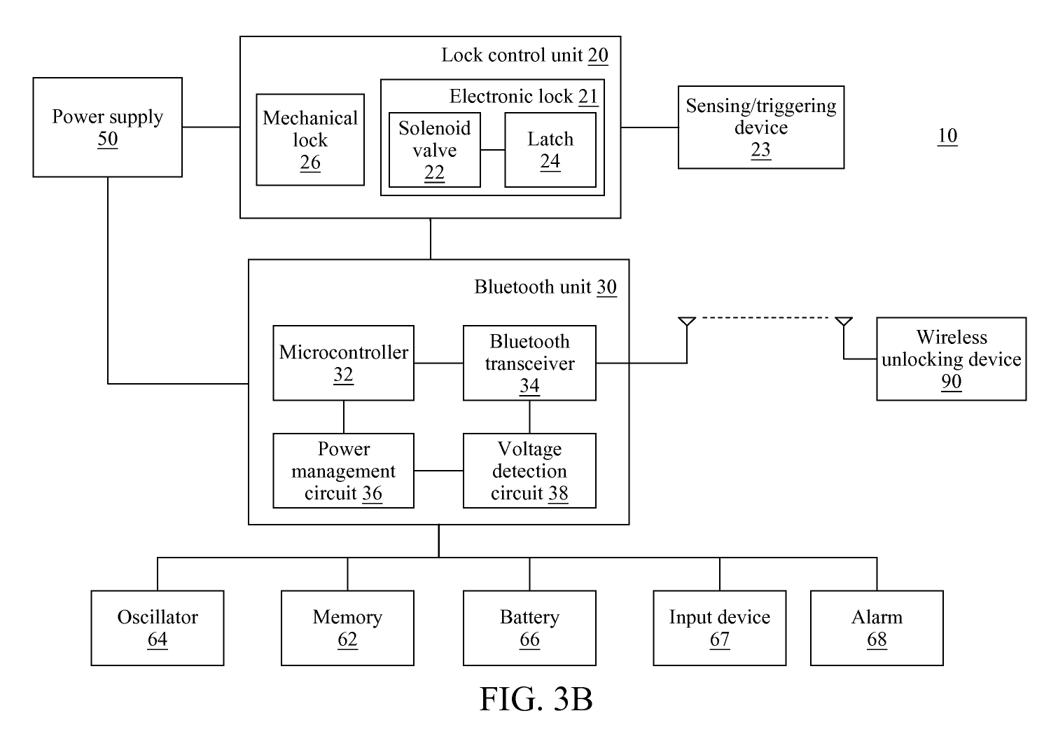

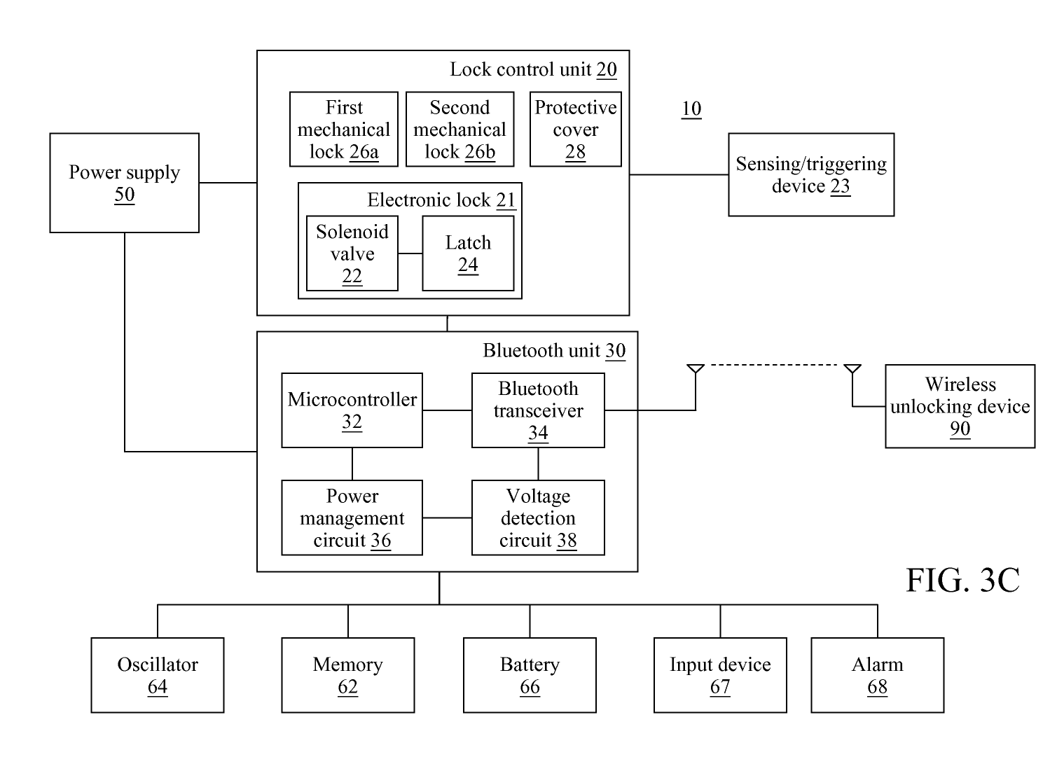

The composite lock 10 can be not only an electrically driven lock but also a mechanical lock. FIG. 3A is a schematic block diagram of a fifth embodiment.

In this embodiment, the lock control unit 20 comprises a mechanical lock 26 and a protective cover 28. The mechanical lock 26 may be a combination lock, or a mechanical lock requiring a key for locking. The protective cover 28 can move between a covering position and an exposing position. When the protective cover 28 is in the covering position (in a locking state), a user cannot operate a dialing disk of the combination lock or use a key to perform unlocking. Only when the protective cover 28 is in the exposing position (in an unlocking state), can the user operate the dialing disk of the combination lock or use the key to perform unlocking.

In this embodiment, locking and unlocking of the composite lock 10 may be performed by one of the two following implementation manners. The first one is automatic locking and identification-based unlocking; the second one is identification-based locking and identification-based unlocking.

There are also two ways for the identification-based unlocking. One is a trigger-based activation mode; and the other one is an automatic activation mode. After activation, connection, and verification, the microcontroller 32 may transmit an unlocking signal to the lock control unit 20. The lock control unit 20 controls the protective cover 28 to horizontally move or rotate, so as to move the protective cover 28 from the covering position to the exposing position. In such exposing position, the user is able to operate the dialing disk of the combination lock or use the key to unlock.

The identification-based locking is similar to the identification-based unlocking. After activation and verification, the microcontroller 32 may transmit a locking signal to the lock control unit 20. The lock control unit 20 controls the protective cover 28 to move horizontally or rotate, so as to move the protective cover 28 from the exposing position to the covering position. In this way, the user cannot operate the dialing disk of the combination lock or use the key to unlock.

FIG. 3B is a schematic block diagram of a sixth embodiment.

The lock control unit 20 comprises the electronic lock 21 and the mechanical lock 26. The electronic lock 21 comprises the solenoid valve 22 and the latch 24. In this embodiment, the electronic lock 21 acts as a hidden lock, and the mechanical lock 26 acts as an exposed lock. The mechanical lock 26 may be connected to the sensing device 23. When the mechanical lock 26 is unlocked by rotating the inserted key or the dialing disk of the combination lock, the sensing device 23 generates a triggering signal, and sends the triggering signal to the Bluetooth unit 30. After the connection and the verification is performed, and then such verification is passed, the solenoid valve 22 of the electronic lock 21 moves from the extended position to the retracted position. As a result, the composite lock 10 is in the unlocking state. However, in this embodiment, the composite lock 10 has both the exposed lock and the hidden lock, so that even if the exposed lock is opened, the hidden lock cannot be opened if the corresponding handheld unit 90 is not available. Accordingly, the security of the composite lock 10 is improved.

FIG. 3C is a schematic block diagram of a seventh embodiment.

The lock control unit 20 comprises the electronic lock 21, a first mechanical lock 26a, a second mechanical lock 26b, and the protective cover 28. The electronic lock 21 comprises the solenoid valve 22 and the latch 24. When the first mechanical lock 26a is unlocked (for example, by pressing or rotating), the sensing device 23 sends a triggering signal to the Bluetooth unit 30. After the connection and the verification are performed, and such verification is passed, the solenoid valve 22 of the electronic lock is moved from the extended position to the refracted position, and the protective cover 28 is moved from the covering position to the exposing position, so that the second mechanical lock 26b is exposed. The user can operate the dialing disk of the combination lock or use a key to unlock the second mechanical lock 26b.

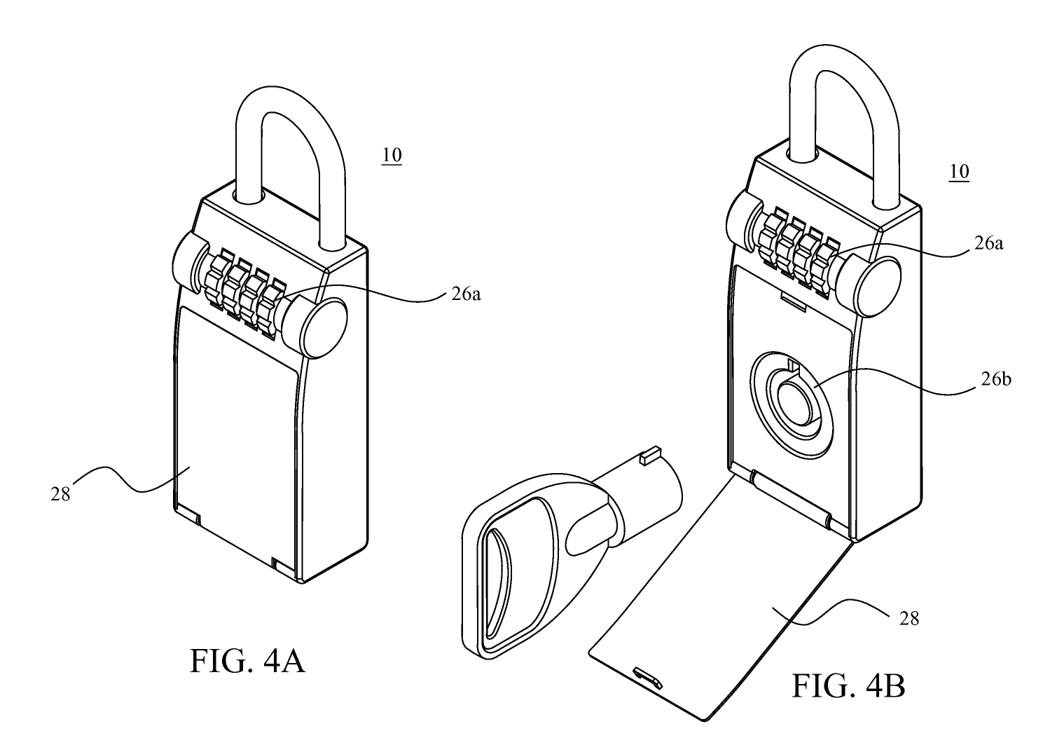

FIG. 4A and FIG. 4B are schematic outside views of the lock control unit. In FIG. 4A, the protective cover 28 is in the covering position. When a user rotates the dialing disk of the combination lock (the first mechanical lock 26a), the Bluetooth unit 30 in the composite lock 10 performs the connection and the verification with the handheld unit 90. When the verification is passed, the solenoid valve 22 of the electronic lock 21 is moved from the extended position to the retracted position, and the protective cover 28 is moved from the covering position to the exposing position. That is to say, the composite lock 10 changes from that shown in FIG. 4A to that shown in FIG. 4B. The use can then use the key to open the second mechanical lock 26b. In this embodiment, only having the handheld unit 90, the correct password, and the key at the same time can the user open the composite lock 10.

What is claimed is:

1. A composite lock, for being used with a handheld unit, the composite lock comprising:
a lock control unit for controlling the composite lock to be in a locking state or an unlocking state; and
a Bluetooth unit, connected to the lock control unit, wherein the Bluetooth unit is for connecting with the handheld unit, the handheld unit is for receiving a returned signal, and the Bluetooth unit is for transmitting an unlocking signal or a locking signal to the lock control unit according to the returned signal, so as to control the composite lock.

2. The composite lock according to claim 1, wherein the lock control unit comprises an electronic lock, the electronic lock comprises a solenoid valve and a latch, and when the lock control unit receives the unlocking signal, the solenoid valve actuates the latch to move from an extended position to a retracted position, and the composite lock is in the unlocking state.

3. The composite lock according to claim 1, wherein the lock control unit comprises a mechanical lock and a protective cover, and when the lock control unit receives the locking signal, the protective cover moves from a covering position to an exposing position, and the composite lock is in the unlocking state.

4. The composite lock according to claim 1, further comprising a verification device, wherein the Bluetooth unit dials a telephone number to reach a remote control device through the handheld unit, the remote control device returns a verification signal to the handheld unit, the handheld unit returns the verification signal to the verification device, the verification device generates a verification code according to the verification signal, the Bluetooth unit transmits the unlocking signal to the lock control unit according to the verification code, so as to enable the composite lock to be in the unlocking state.

5. The composite lock according to claim 4, wherein the verification device is a Dual Tone Multi Frequency (DTMF) decoder, and the DTMF decoder receives a DTMF signal and converts the DTMF signal into a digital signal.

6. The composite lock according to claim 1, wherein the composite lock comprises a sensing device, the sensing device is connected to the lock control unit, the sensing device receives a sensing signal, the sensing device generates a triggering signal, and the Bluetooth unit is used to perform connection with the handheld unit.

7. The composite lock according to claim 6, further comprising an alarm, wherein the sensing device receives the sensing signal, and when handheld unit is not detected by the Bluetooth unit, the alarm sends out an alarm.

8. The composite lock according to claim 6, wherein the lock control unit comprises an electronic lock and a mechanical lock, the electronic lock comprises a solenoid valve and a latch, when the mechanical lock is unlocked, the sensing device generates the triggering signal, the Bluetooth unit transmits the unlocking signal to the lock control unit, and when the lock control unit receives the unlocking signal, the solenoid valve actuates the latch to move from an extended position to a retracted position, and the composite lock is in the unlocking state.

9. The composite lock according to claim 1, wherein the Bluetooth unit judges, according to an estimated distance, whether the estimated distance is smaller than a threshold value, and if the estimated distance is smaller than the threshold value, the Bluetooth unit transmits the unlocking signal to the lock control unit, so as to control the composite lock to be in the unlocking state.

10. The composite lock according to claim 1, wherein the Bluetooth unit requests the handheld unit to input a password, and when the password input by the handheld unit is correct, the Bluetooth unit transmits the unlocking signal to the lock control unit.
